(19) United States
(12) Patent Application Publication
(10) Pub. No.: US 2024/0311736 A1
(43) Pub. Date: Sep. 19, 2024

(54) QUERY CHAIN - DECLARATIVE APPROACH FOR ON-DEMAND DASHBOARDING

(71) Applicant: Selector Software, Inc., Santa Clara, CA (US)

(72) Inventors: Varija Sriram, Santa Clara, CA (US); Kannan Kothandaraman, Santa Clara, CA (US); Nitin Kumar, Santa Clara, CA (US); Surya Chandra Sekhar Nimmagadda, Santa Clara, CA (US); Debashis Mohanty, Santa Clara, CA (US); Rudramahesh Rugge, Santa Clara, CA (US); Sirish A. Kondi, Santa Clara, CA (US)

(21) Appl. No.: 18/183,673

(22) Filed: Mar. 14, 2023

(51) Int. Cl. G06Q 10/0639

(52) U.S. Cl. CPC G06Q 10/06393

(57) ABSTRACT

Systems, apparatuses, and methods for creating on-demand dashboards for inspecting performance metrics of hardware and/or software infrastructure are described. A request is received, from a user device, to inspect one or more performance metrics of a network connected service. An operations management system generates metadata from data ingested from one or more data sources associated with the network connected service. A plurality of database queries generated based on the contextual metadata are identified and at least a portion of the plurality of database queries are resolved. One or more dashboards facilitating inspection of each of the one or more performance metrics are generated based at least in part on the resolved portion of the plurality of database queries.

### BACKGROUND

### Description of the Related Art

Currently, for operations management for network-based services, users have to create multiple static dashboards for each operational monitoring tool. These dashboards can present metrics associated with functionalities of a given network-based service, as generated by a given operational monitoring tool. In case of issues such as outages, users have to search for relevant dashboards in the dashboard lists and/or directories and look at key performance metrics to determine the root-cause of the issue.

Users may store pre-built widgets and dashboards in specific folders tagged with specific entity or location name. For example, all dashboards related to a particular data center can be stored in a given datastore, and dashboards associated with another data center is stored in a separate data store or directory. In case collaborative efforts are required to troubleshoot issues, the users would generally share the separately stored widgets and dashboard snapshots with other users through email or photo share in order to perform collective debugging. However, the conventional ways of monitoring and troubleshooting issues in network-based or cloud-based services are inefficient due to lack of dynamic context-based information in these dashboards. Further, each time an issue is identified, these dashboards need to be manually or programmatically updated and the updates need to be restored in the data store. Pinpoint identification of issues using such static dashboards is therefore not ideal.

In view of the above, improved systems and methods for on-demand context-based dashboarding are needed.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of an exemplary network implementation of an operations monitoring system.

FIG. 2 is a block diagram of exemplary implementation of various units of the operations monitoring system.

FIG. 3 is a block diagram illustrating workings of a data aggregator unit of the operations management system.

FIG. 4 is a block diagram illustrating workings of a data analyzer unit of the operations management system.

FIG. 5 is a block diagram illustrating workings of a metric generation unit of the operations management system.

FIGS. 6A-B illustrate FIG. 6A and 6B illustrate exemplary performance metric dashboards generated by the operations management system.

FIG. 7 illustrates an exemplary dashboard, as displayed on a graphical user interface of a computing device.

FIG. 8 is an exemplary method for generating query-based dashboards for inspection of performance metrics of a network service.

FIG. 9 illustrates and exemplary block diagram for generating query-based dashboards.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for query chain on-demand dashboarding are disclosed. An operations management system comprises of a data aggregator, a data analyzer, and a metrics generator. The data aggregator ingests data from multiple data sources, each associated with performance of elements of a particular hardware infrastructure (e.g., physical datacenters) or software infrastructure (e.g., cloud or network-based services). The data includes information relating to performance metrics as given by events, metrics, logs, and configurations associated with the hardware or software infrastructure. The data analyzer is configured to decouple the different types of the data, normalize the data, and provide a source agnostic mechanism to extract, enrich, process, and redirect data to relevant data storage locations, adequate to each different type of data. The data analyzer applies policy-based and/or heuristic-based rules to the processed data to create contextual metadata. The metadata is further utilized to generate a plurality of database queries to enable querying of the performance metrics by a user device. The metrics generator can receive a such query from a user device and present on-demand real-time dashboards by resolving the query. The dashboard can be presented on a graphical user interface of the user device for troubleshooting issues identified in the hardware of software infrastructure.

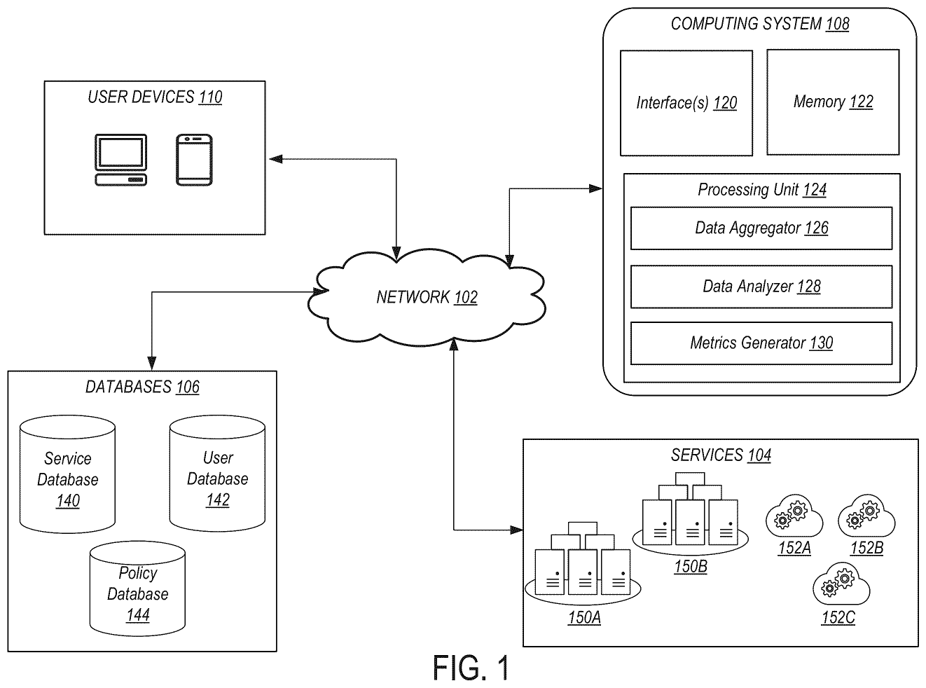

FIG. 1 illustrates an exemplary network implementation 100 for functioning of an computing system 108 (alternatively referred to as operations management system or OMS 108). In an implementation, the operations management system 108 is configured to manage operations and maintenance of one or more services 104, over a network 102. In one implementation, services 104 managed by the operations management system 108 can include one or more physical infrastructures, e.g., datacenter 150A and datacenter 150B (collectively referred to as datacenters 150). Further, the services 104 can also include software services, e.g., cloud-based services 152A, 152B, and 152C (collectively referred to as cloud services 152). In an example, datacenters 150 may include on-site datacenters such as Information Technology (IT) equipment, such as computers, networks, and storage systems, and are located and used to support the operation of a particular business. The equipment in the datacenters 150 can be used to run important applications, services, and store critical data for the business. Similarly, cloud services 152 include services that may allow businesses to access and use IT resources, such as applications, development platforms, servers, storage, and virtual desktops, over the internet or a dedicated network. Other examples of services 104 are contemplated.

The operations management is configured to provide analysis of the workings of the services 104 to one or more user devices 110 over the network 102. In one example, the user devices 110 include devices used by IT administrators, network engineers, and/or maintenance personnel to inspect performance of the services 104, either on-site or remotely. User devices 110 can include personal computers, digital assistants, smartphones, tablets, and laptops, can be connected to the network 102 or operate independently. These devices may also have various external or internal components, like a mouse, keyboard, or display. User devices 110 can run a variety of applications, such as word processing, email, and internet browsing, and can be compatible with different operating systems like Windows or Linux.

The operations management system 108 is further connected to one or more databases 106, over the network 102, such that data generated as a result of execution of instructions by the operations management system 108, is stored in at least one of the databases 106. In one implementation, the databases 106 can be internal to the operations management system 108. The databases 106 at least comprise a service database 140, a user database 142, and a policy database 144. The service database 140, in an implementation, can be used to store data associated with one or more of the services 104. The data can include business data, location data, equipment data, maintenance data, and the like for one or more services 104. The user database 142, in an implementation, stores data associated with users of the user devices 110. The data can include user registration data, device-type data, user designation data, and the like. Further, policy database 144 can store data associated with policies and heuristics-based rules, that can be used by the operations management system 108 to generate on-demand dashboards for the user devices 110.

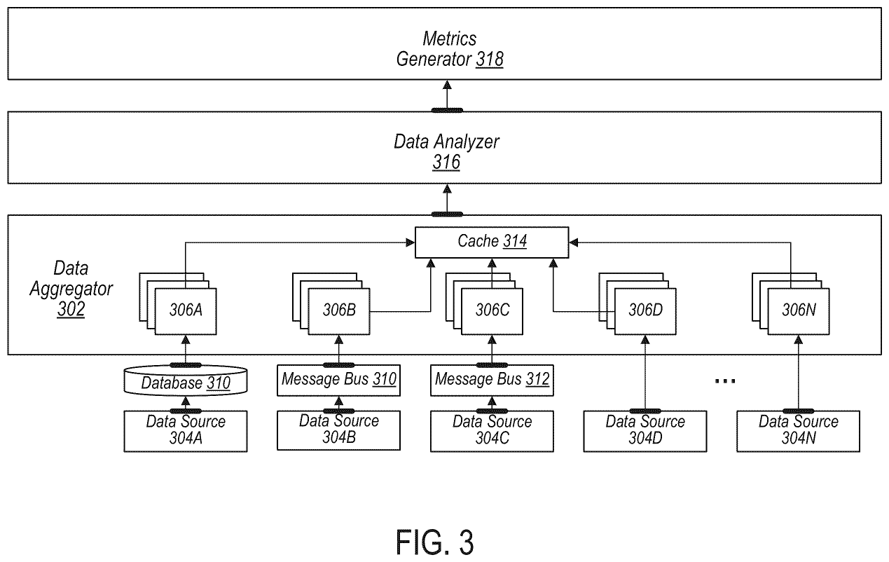

As shown in the figure, the operations management system 108 comprises one or more interface(s) 120, a memory 122, and a processing unit 124. In an implementation, the one or more interface(s) are configured to display data generated as a result of the processing unit 124 executing one or more programming instructions stored in the memory 122. The processing unit 124 further comprises data aggregator 126, data analyzer 128, and metrics generator 130. The data aggregator 126 is configured to ingest data associated with one or more service of the services 104, from a variety of data sources (as detailed in FIG. 3). In an implementation, the ingested data is indicative of operational parameters of the services 104 being monitored. The data, in an example, can include information pertaining to performance metrics, events, logs, metrics, and the like. In an implementation, the data is heterogenous, in that, the content as well as the format of the data is non-consistent. The data aggregator 126 is configured to ingest such heterogenous data from multiple data sources, such as, network management interface data, data services pipeline data, time-series data, and the like. The data can also include data from existing data logging and information technology (IT) monitoring systems. In an implementation, data from each different data source is collected by the data aggregator 126 using one or more data collection engines, as further described in FIG. 3. The collected data is processed and can be stored by the data aggregator 126, e.g., in the service database 140.

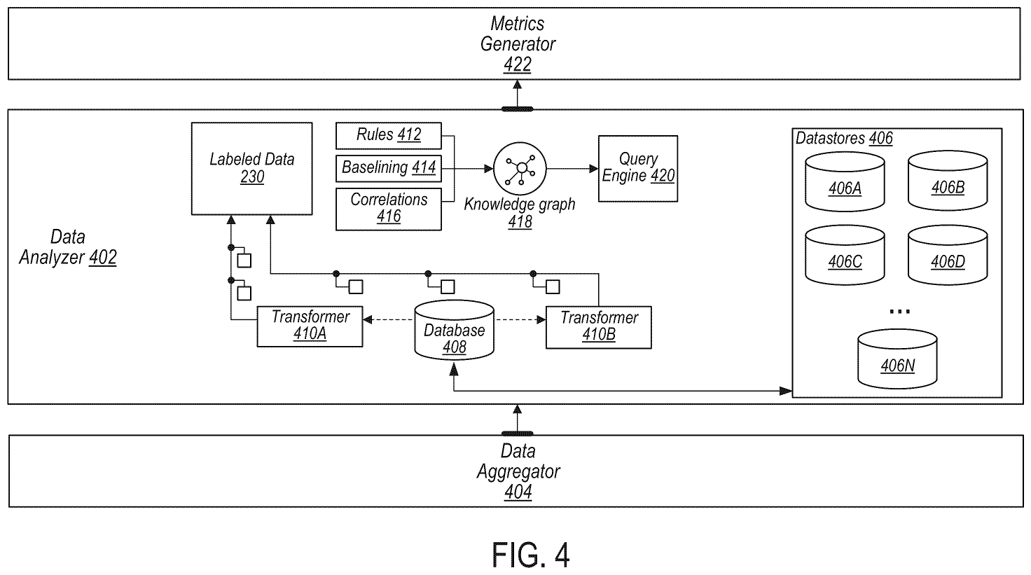

The data analyzer 128 analyzes the collected data and provides an abstract view of the data, for example, by decoupling the data from its source. In an implementation, the abstract view of the data by decoupling of data can be facilitated by the use of virtual machines and/or containers. The decoupled data can then be normalized by the data analyzer 128 and redirected to specific storage repositories (not shown), created for each type of data. The decoupled and normalized data, in an implementation, is utilized by the data analyzer 128 to generate contextual metadata associated with a plurality of performance metrics for inspection of one or more services 104, in real-time or near-real time. In an implementation, the contextual metadata is generated in the form of labels, such that the collected data, when infused with these labels, can be cross-correlated to monitor performance metrics of the one or more services 104 (as detailed in FIG. 4).

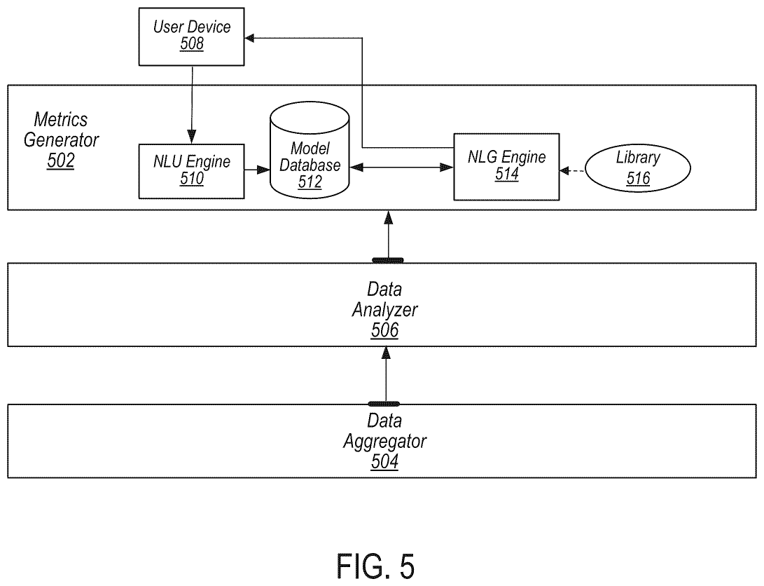

The data analyzer 128 is further configured to use the contextual metadata to generate a plurality of database queries, such that a given database query, when resolved, provides information on one or more performance metrics of a service 104 being monitored. For instance, the data analyzer 128 generates all possible database queries for processed data stored in various repositories. In an implementation, the database queries can be used by metrics generator 130 to create dashboards, as requested by user devices 110, based at least in part on resolving a portion of the generated queries responsive to commands received from the user device 110. In an example, the commands received from a given user device 110 can be in natural language, and the metrics generator 130 can convert a natural language command into a programming language (e.g., SQL) command using one or more natural language processing models (as detailed in FIG. 5).

The metrics generator 130, in an implementation, is configured to generate on-demand dashboards for display on one or more graphical user interfaces of the user devices 110. The on-demand dashboards can facilitate a user of a given user device 110 (such as an IT administrator), to root-cause an issue with a given service 104 and troubleshoot the issue, without the requirement of an additional monitoring tool or application on the user device 110. Further, the on-demand dashboards are updated in real-time such that every event occurrence for a given service 104 is accessible to the user concurrently, thereby reducing time spent on root-causing of the issue. The user can simply send plain text messages (e.g., using an instant messaging application) from their user device 110, to request for information on various performance metrics for a service 104. Based on the received messages, the metrics generator 130 can update existing dashboards and/or create new dashboards on the fly to provide important insights regarding performance of the service 104, to the user device 110.

In an implementation, the operations management system 108 may be based on declarative data pipelines such that the system can be programmed to specify desired outcomes of one or more data processing tasks, rather than specifying the exact steps required to achieve those outcomes. That is, the system 108 is programmed in a manner such that users can focus on what they want to accomplish with their data, rather than programming each low-level implementation detail of how to transform and manipulate the data. In an example, the system 108 may be implemented using a domain-specific language (DSL) or a graphical user interface (GUI). This may make it easier for users to understand and use the system 108, and can also make it easier for developers to build and maintain the system 108 for future applications.

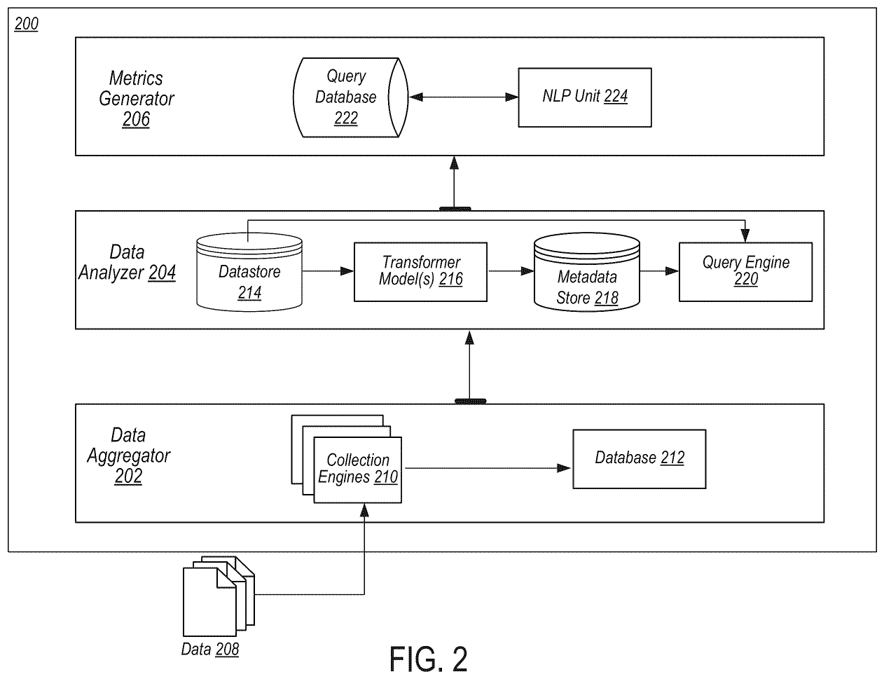

Turning now to FIG. 2, a block diagram of exemplary implementation of various units of an operations management system 200 (or “OMS 200”) is illustrated. For the sake of brevity, FIG. 2 describes the detailed working of a data aggregator 202, a data analyzer 204, and a metrics generator 206, of the OMS 200. Other processing and non-processing units of the OMS are similar to as that described for computing system 108 in FIG. 1.

In an implementation, the OMS 200 can have access to a variety of data sources (as shown in FIG. 3), such that the data aggregator 202 ingests data 208 from these data sources using a set of custom-built collection engines 210. The collection engines 210, in several implementations, can be configured for ingesting data 208 from one or more data sources (not shown), either by pulling data 208 from the data sources or using push notifications to collect data 208 from the data sources.

In an example, the one or more data sources can include IT monitoring and data logging systems. In an implementation, data aggregator comprises pre-integrated collection engines 210 for each different type of data source, such that heterogenous data 208 from varied data sources can be easily collected for analysis. In one implementation, data 208 can also be collected directly from one or more network or cloud services (e.g., services 104 of FIG. 1) being monitored.

In an implementation, the data aggregator 202 can connect to existing inventory or Configuration Management Database (CMDB) tool associated with an entity being monitored. According to the implementation, the data 208 collected from such tools can include static inventory definitions from a file or dynamic definitions via an Application Programming Interface (API). The data aggregator 202 can also integrate with an existing instance of such a tool (e.g., Netbox instance, etc.) and/or provide inventory as a service using an internal Netbox instance (not shown).

The collected data 208, is used to create a database 212, such that data from the database 212 can be used by one or more components of the OMS 200 for real-time telemetry and enrichment. Further, each collection engine 210, in an implementation, can be cloud-native, such that scaling out of the collection engines 210 for new types of data 208 is possible. The collection engines 210 are configured to provide an entry point for ingestion of data into the OMS 200. Different types of data 208 and associated collection engines 210 are described in detail with respect to FIG. 3.

In an implementation, the collected data 208, from the database 212 can be accessed by the data analyzer 204 to create contextual metadata. The collected data 208, in one example, may lack context and therefore enrichment of the data 208 with context-based metadata may be required. To this end, the data analyzer 204 is configured to different sets of data from the database 212, store the sets of data in datastore 214, and process the data using one or more transformer models 216. In an implementation, each different set of data may represent heterogenous data of different types (e.g., collected from different data sources), such as metrics, events, logs, configurations, operational states, and the like. The data analyzer 204 is configured to process the sets of data to normalize the data contained therein and decouple the data from their respective data sources. That is, the data analyzer 204 processes the data to render the data source agnostic so as to facilitate extraction, enrichment, and redirection of said data to appropriate storage repositories (not shown), for each different type of data.

Once the data is normalized and decoupled from its respective source (i.e., processed data), the data analyzer 204 uses transformer models 216 to create contextual metadata from the processed data. The contextual metadata is stored in a metadata store 218. In an implementation, the metadata is created in the form of labels, such that processed data can be correlated to provide insights into the performance of one or more services being monitored. Further, processed data, along with associated metadata, is fed into a query engine 220 to generate all possible database queries from the processed data, that would enable the metrics generator 208 to create dashboards for display on a user device GUI (not shown).

In an implementation, the created database queries may be stored in a query database 222. In an example, each database query can be created in a specific programming language, e.g., SQL, the programming language determined based at least in part on a type of service being monitored, source of data from which query has been generated, type of data from which query has been generated, and the like. In an implementation, the query database 222 is accessible by a natural language processing unit 224 (or NLP unit 224), such that the NLP unit 224 can resolve one or more of these queries responsive to requests received from a user device (not shown). According to the implementation, a given user device can send a request to the OMS 200, e.g., for inspecting a given performance metric associated with a given service. The request, in one example, can be received in plain text. In response to receiving such a request, the NLP unit 224 converts the plain text into an appropriate query and correlates the query to one or more queries stored in the query database 222. Based on the correlation, the metrics generator 208 resolves the queries found in the query database 222 to create dashboards for inspection of the given performance metric. These dashboards are presented to the user device over a GUI.

In an implementation, the metrics generator 208 is configured to create the dashboards in an on-demand manner. That is, instead of pre-defined dashboards for inspecting various performance metrics of a given service being monitored, the metrics generator 208 creates the dashboards on the fly by resolving queries from the query database 222. According to the implementation, these dashboards are created at least based in part on requests received from a user device to inspect one or more performance metric associated with a given service or a part of an infrastructure of the given service. In case of anomalies found in the performance metric, the events responsible for the anomalies may be flagged and ranked by the metrics generator 208 within the created dashboards. The formation of dashboards based on correlation of queries is further explained with respect to FIG. 5.

Referring now to FIG. 3, a block diagram illustrating workings of a data aggregator unit of an operations management system (OMS) is illustrated. As described in the foregoing, a data aggregator unit, such as the data aggregator 302 of FIG. 3, is configured to ingest heterogenous data from multiple data sources, the data representative of operational information associated with one or more services (e.g., a network-based service or a cloud-based service). In an implementation, the data sources can either belong to third-party monitoring services and/or data can be ingested directly from the service being monitored.

In the implementation shown in FIG. 3, the data aggregator 302 ingests data from a plurality of data sources, including data sources 304A-N (collectively referred to as data sources 304). In an implementation, each different data source 304 can contain data in different formats that may be generated as a result of operations executed within the service being monitored. Further, collection engines 306A-N may each be associated with a particular data source 304. In an implementation, data collection engines 306 comprise systems designed to gather, process, and store data from various data sources 304. The data collection engines 306 are configured to collect and store data from a single source, or can comprise complex systems that can handle data from multiple sources and perform advanced analytics on that data. In an implementation, some data collection engines 306 may be designed to analyze smaller services (e.g., IT operations of a small or mid-sized organization), while other data collection engines 306 may be intended for use by large organizations with sophisticated data needs. In several implementations, data collection engines 306A-N can be implemented in a variety of ways, including through software programs, web applications, or specialized hardware systems (not shown). They may be used in combination with other tools, such as data visualization software or machine learning algorithms, to analyze and interpret the collected data.

The ingested data, in an implementation, can be varied in terms of source of data and type of data. Some non-limiting examples of ingested data are described as follows:

Data Source 304A: Network management interface data-Network management interface data refers to data that is generated as a result of protocols used to manage and operate network devices. For example, network management interfaces can stream data from one or more network devices and provide features for managing the operational and configuration states of switches.

Data Source 304B: Data from data pipeline services-Data pipeline services (e.g., Apache Kafka event store and stream-processing platform) are used to create data pipelines and applications that stream data. One example of how a data pipeline can be used is to move data between different systems by collecting and storing streaming data. These services can also help create a platform that communicates and processes data between two services or applications.

Data Source 304C: Time Series Data-Static data is data that has a specific start and end time and is only relevant within a certain time frame. Time series data, on the other hand, is a series of data points that measure the same thing over a set period of time. It can be thought of as a series of numerical values, each with its own time stamp and set of labeled dimensions. Time series data is becoming increasingly common, and time series databases have been growing in popularity among developers in recent years. While static data is relatively straightforward to analyze, time series data is more complex because it depends on various dynamics and often involves analyzing data over time to identify anomalies.

Data Source 304D: Representational state transfer (REST API) data-A REST API is a type of application program interface that follows a specific architectural style and uses HTTP requests to access and manipulate data. This data can be accessed and modified through various actions such as GET, PUT, POST, and DELETE, which allow for the reading, updating, creating, and deleting of resources.

Data Source 304N: Monitoring tool data-Data and IT monitoring tools help organizations extract value from their server data, enabling efficient management of applications, IT operations, compliance, and security monitoring. These tools may comprise of an engine at their core that collects, indexes, and manages large amounts of data, which can be in any format and can reach terabytes or more per day. Such tools can analyze data dynamically, creating schemas on the fly, allowing users to query the data without needing to understand its structure beforehand. It can be used on a single laptop or in a large, distributed architecture in an enterprise data center. These tools can provide a machine data fabric, including forwarders, indexers, and search heads, which allows for real-time collection and indexing of machine data from any network, data center, or IT environment.

Other types of data from various other data sources are contemplated.

In an implementation, each different type of data received from data sources 304 is ingested by the data aggregator 302 using a particular data collection engine 306, as shown. Further, the data may be ingested using a dedicated message bus, through a datastore associated with the data source, and/or directly through the data source without the use of auxiliary infrastructure. As shown in FIG. 3, data from data source 304A may be collected in database 308 and retrieved from the collection engine 306 A through the database 308. Further, messages buses 310 and 312 may be configured between collection engine 306B and data source 304B, as well as between collection engine 304C and data source 304C. As described in the foregoing, each collection engine 306, in an implementation, can be cloud-native, such that scaling out of the collection engines 304 for new types of data may be possible. The collection engines 306 are configured to provide an entry point for ingestion of data into the OMS.

In an implementation, the data collected by each data collection engine 306 is stored in a cache memory 314 associated with the data aggregator 302. In an implementation, the cache 314 may comprise a fast access memory, such that data from the cache 314 can be frequently accessed from the main memory or storage (not shown) by other components of the OMS, such as data analyzer 316 and/or metrics generator 318. In one example, the cache 314 is typically located on a processor chip or on a separate memory module and operates at a higher speed than main memory or storage. Other storage locations for the data are contemplated.

Turning now to FIG. 4, a block diagram showing workings of a data analyzer unit of an operations management system (OMS) is illustrated. In an implementation, data ingested by the OMS through the data aggregator (e.g., data aggregator 302 described in FIG. 3) is further processed by the data analyzer 402 to generate contextual metadata for the data. The contextual metadata can facilitate for correlation of different sets of data, collected from different data sources and heterogenous in nature.

As shown in FIG. 4, the data analyzer 402 accesses data collected by a data aggregator 404. In an implementation, since data collected by the data aggregator 404 is heterogenous, each different type of data may have its own characteristics, such as schema, format, encapsulation mechanisms, and the like. To this end, depending on the type of data (and data source from where the data is collected), the data analyzer 402 processes the data such that information related to events, metrics, logs, configurations, flow, and the like associated with a monitored service and received from different data sources can be correlated to generate actionable insights.

The data analyzer 402, in one implementation, restructures data from different sources into a plurality of data stores 406, including but not limiting to, time series database 406A, SQL database 406B, log database 406C, graph database 406D, and documents database 406N. Other databases are contemplated. According to the implementation, the data analyzer 402 retrieves data from a cache associated with data aggregator (e.g., cache 314 of FIG. 3).

As described in the foregoing, the data may represent metrics, events, logs, configurations, operational states, and the like with operation of a service or application being monitored. In an implementation, the data analyzer 402 processes the data from each database in order to decouple the data from its physical infrastructure. That is, data is abstracted such that the data represents performance metrics associated with operation of the service or application being monitored, and not the physical infrastructure of the service or application from where it is generated (e.g., routers, switches, hubs, repeaters, gateways, bridges, and modems, etc.). According to the implementation, the abstraction is performed by the data analyzer 402 using virtual machines and/or containers.

The decoupled data is then normalized by the data analyzer 402. In an implementation, data can be normalized by converting it into a standardized format that can be easily integrated and analyzed. The data analyzer 402 is configured to normalize the data by first identifying data sources and types of data for each datastore 406. The data analyzer 402 then determines one or more common attributes or fields that are shared across the data stores 406. The data is then mapped from the different data stores 406 to a common data model or schema and transformed to a consistent format, e.g., combining multiple fields into a single field. The data can then be validated to ensure accuracy and completeness. The normalized and decoupled data, in one implementation, is stored in database 408.

In an implementation, the data analyzer 402 uses one or more transformers, e.g., transformer 410A and transformer 410B (collectively referred to as transformers 410), to generate contextual metadata from the data. In various implementations, one or more of transformers 410 is configured to extract metadata from log messages or inventory data. In an example, the transformers 410 include one or more of normalization transformers, enrichment transformers, summarization transformers, encoding transformers, and the like. Further, the metadata at least includes labels. The data to be transformed includes selecting one or more specific subsets of the data or all of the data for labeling. The data is then preprocessed by the transformers 410 to convert the data into a suitable format for labeling. The preprocessing, in one example, may involve cleaning the data to remove errors or inconsistencies, and/or reshaping the data to conform to a specific structure or schema. The transformers 410 then performs labeling to the data. In an implementation, the labeling can include assigning labels to the data using predefined parameters by using automated labeling tools or algorithms. The labeled data 430 is validated to ensure that the labels are accurate and complete.

In an implementation, the labeled data 430 undergoes one or more analysis processes, e.g., rules processing 412, baselining 414, and correlation function 416, by the data analyzer 402. During rules processing 412, the data analyzer 402 can apply policy-based or heuristic-based rules to the data in order to detect anomalies in the data. For example, the data analyzer 402, may process event data to flag one or more events, such that each time such an event occurs, the OMS transmits alerts associated with such events. In one implementation, the OMS sends alerts to one or more user devices when such an anomaly is detected. In one example of policy-based rules, an anomaly is identified in a given metric, if the given metric's value does not correspond to a threshold (e.g., a given metric should be between a high and a low threshold) during certain periods of time in a given day or week. Further, for heuristic-based rules, a behavior for the given metric may be observed during a time window and the threshold learned by the data analyzer 402.

In another implementation, the labeled data is further processed by the data analyzer 402, using the baselining process 414. Baselining is the process of establishing a set of baseline or reference measurements or values for a system or process. These measurements or values serve as a benchmark or point of reference against which future measurements or changes can be compared. In an implementation, the baselining process 414 may include analyzing labeled data to establish a baseline for performance metrics associated with a service under monitoring. This baselined data, in an example, is then used to monitor and measure changes in the performance metrics over time, and to identify areas that generate anomalies and/or for improvement or optimization.

In yet another implementation, the data is further processed by the data analyzer 402 by performing a correlation function 416. The correlation function 416 renders a statistical relationship between two or more variables within the data. For instance, when two variables are correlated, a relationship between these variables is defined, such that changes in one variable are associated with positive, negative, or zero changes in the other. A positive correlation may mean that the variables are directly proportional to one another. For example, there may be a positive correlation between a device traffic on a network device, with the number of active users. That is, more the number of users, the more traffic the network device encounters. On the other hand, a negative correlation may mean that the variables are inversely proportional to one another. For example, there may be a negative correlation between the bandwidth of a network with the number of active users. That is, the bandwidth of a network would increase as the number of active users decreases. Further, zero correlation may mean that there is no relationship between the two variables.

In one implementation, the data is correlated by the data analyzer 402 in order to define relationships between different data types. The correlated data, in an example, may facilitate detecting performance metrics of a monitored service, as a function of other performance metrics associated with the monitored service. This in turn can be advantageous when collaborative efforts are needed between several teams in order to root-cause, debug, and troubleshoot an issue.

Once the data has been processed using one or more processes described above, the data analyzer 402 creates a knowledge graph 418 using the processed data. In an implementation, the knowledge graph 418 is a structured representation of information about a particular service, application, or entity under surveillance. The knowledge graph 418 may be used to represent relationships and connections between different data associated with the service, application, or entity under surveillance. The knowledge graph 418, in one implementation, consists of a set of nodes, which represent type of data, and edges, which represent relationships between the data. The information associated with each node and edge is typically stored in the form of attributes or properties. Other implementations are contemplated.

In an implementation, the knowledge graph 418 can be fed as an input into a query engine 420. According to the implementation, the query engine 420 is configured to generate all possible database queries associated with the data represented in the knowledge graph 418. In one implementation, based on the given context in an initial query, subsequent queries are generated. For example, based on an initial query generated for a user device to inspect health of a data center, the query engine 420 would generate any subsequent queries focusing on metrics having anomalies (e.g., not meeting particular conditions) in that particular data center. This may ensure that an end-user would not require building these queries and/or searching for anomalies metrics manually.

The database queries can be used by a metrics generator 422 to create on-demand dashboards for the service or application being monitored (as detailed in FIG. 5). In one implementation, each dashboard may be created on-demand, in response to receiving requests from a user device (such as user device 110 of FIG. 1).

Turning now to FIG. 5, a block diagram showing workings of a metric generation unit of an OMS is illustrated. As shown in the figure, the metrics generator 502, may use data ingested by data aggregator 504 and processed by data analyzer 506. In an implementation, the metrics generator 502 is configured to receive a message from a user device 508, resolve one or more target queries from the queries generated by a query engine (e.g., query engine 420 of FIG. 4), and create one or more dashboards to be displayed at a graphical user interface (GUI) of the user device 508.

In one implementation, a natural language understanding (NLU) engine 510 is configured to identify one or more messages received by the metrics generator 502 from the user device 508. The messages, in one example, may include a request in plain text to inspect performance metrics of a given service or application. In an implementation, the NLU engine 510 identifies the request and extracts meaning from the plain text message. by determining its meaning, structure, and intent. One or more methods, such as sentiment analysis, sentence structuring, and/or other relevant models may be performed by the NLU engine 510 to extract the meaning from the request. These models, in an implementation, are stored in the model database 512.

In another implementation, based at least part on the extracted meaning and one or more other machine learning models accessed from the model database 512, the metrics generator 502 further resolves target database queries. That is, the metrics generator 502 identifies target queries from the list of all possible queries, such that resolving the target queries would provide real-time information on performance metrics requested to be inspected by the user device 508.

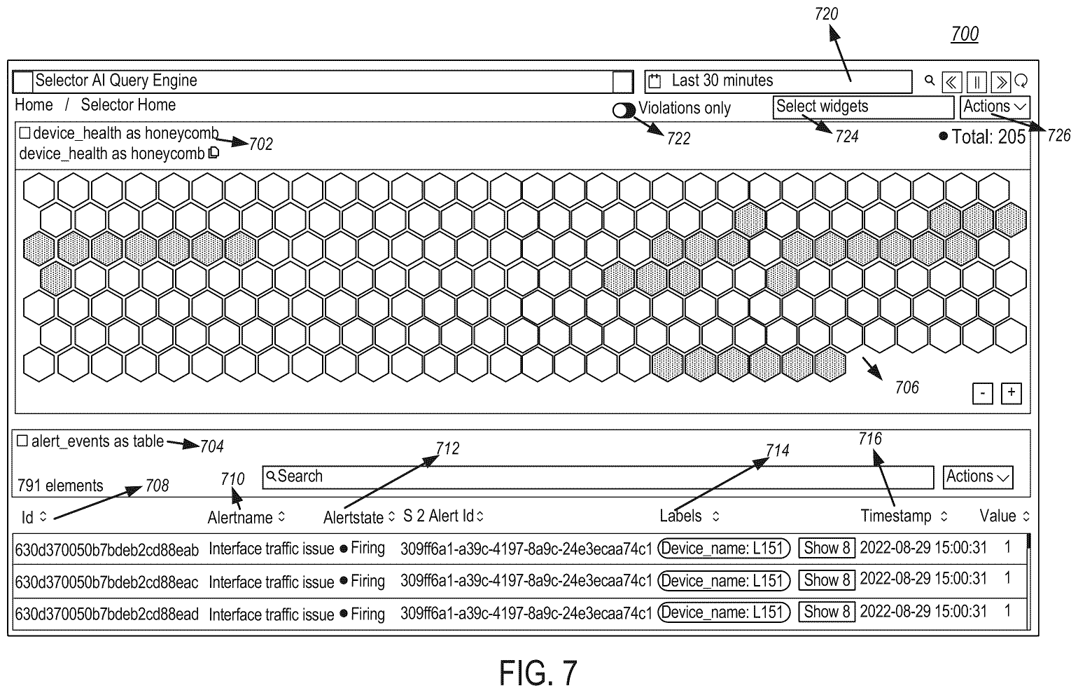

Once these queries are resolved by the metrics generator 502, a natural language generation (NLG) engine 514 is configured to generate on-demand dashboards for the user device 508. In an implementation, the NLG engine 514 is configured to determine data to be presented in the dashboards, at least based in part on the resolved queries. The NLG engine 514 is further configured to create dashboards by applying a set of rules, generating human-readable text, generating a summary of data, generating responses to user queries, and/or generating descriptions of images. An exemplary dashboard is described with reference to FIG. 7.

In an implementation, the NLG engine 514 is configured to generate the one or more dashboards by executing instructions available in a given programming library 516. In an example, the programming library is a D3.js plot. D3.js (short for Data-Driven Documents) is a JavaScript library for creating interactive visualizations for the web. It is often used for creating charts, plots, and other graphical representations of data. To create a plot with D3.js, the NLG engine 514 can structure data in the form of a simple array of numbers or a more complex data structure such as a table with multiple columns and rows. The D3.js plot is then used to create a plot by specifying the visual encoding of the data, such as the x and y coordinates of the data points, the size of the data points, and the color of the data points. The D3.js functions to bind the data to the plot and draw the plot on a web page presented on the GUI of the user device 508. Other programming libraries can be used to create the dashboards and are contemplated.

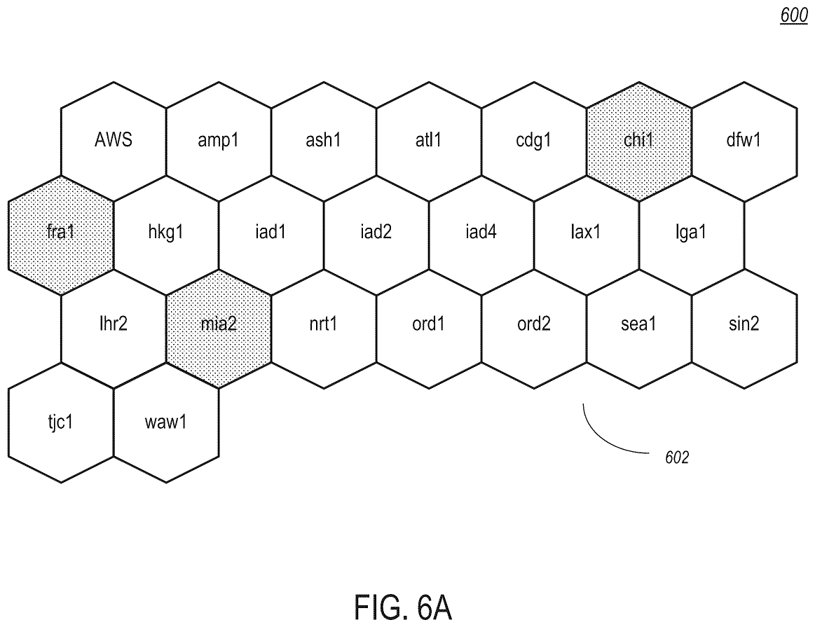

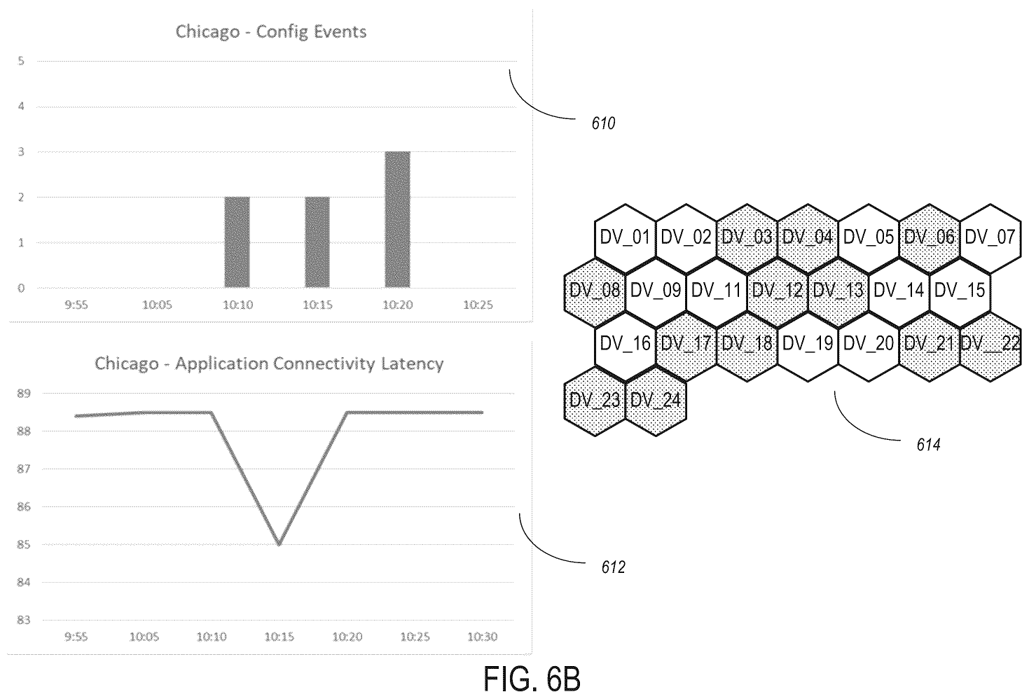

FIG. 6A and 6B illustrate exemplary performance metric dashboards generated by an operations management system (OMS). As described in the foregoing, the OMS (e.g., the OMS 200 of FIG. 2) is configured to ingest data from one or more data sources associated with a service or an application being monitored. The ingested data is processed to generate on-demand dashboards responsive to requests received from a user device. In one implementation, each dashboard presents one or more performance metrics, including but not limiting to device health, configuration events, application latency, network congestion, and the like for the service or application under surveillance. The dashboards are generated by the OMS and presented at a graphical user interface of one or more user devices.

In an exemplary performance metric shown in FIG. 6A, a honeycomb structure 602 is generated, such that each hexagonal part of the honeycomb 602 is indicative of a physical site or location wherein applications, services, and/or infrastructure is being monitored. As depicted, each site or location represented by a given hexagonal part, is assigned an identification, the identification representing the location name. Further, the shaded hexagons, in an implementation, may represent areas or sites where one or more issues in the operations of a given service, have been flagged. In the example, shown in FIG. 6A, the sites chi1 representing Chicago, fra1, representing France, and mia2, representing Miami, have been flagged as having issues. It is noted that the performance metric can be generated in one or more other structures apart from a honeycomb structure, e.g., based on an instruction received from the user device. Such structures are contemplated.

In an implementation, the honeycomb 602 is displayed onto the GUI of a user device, such that interacting with any of the hexagonal parts of the honeycomb 602 through the user device, would trigger creation and display of contextual dashboards by the OMS, for the location represented by that hexagonal part. Exemplary contextual dashboards are depicted in FIG. 6B. Further, in another implementation, the performance metrics and dashboards shown in FIG. 6A-B may be displayed directly onto an interface of an existing instant messaging or project management application pre-loaded onto the user device.

FIG. 6B illustrates a plurality of on-demand contextual dashboards generated by the OMS and displayed on a GUI of a user device. Referring to the example described in FIG. 6A, a user of a user device may interact with one of the hexagonal parts of the honeycomb structure 602, in order to trigger generation of the contextual dashboards associated with a certain entity, device, or location associated with the selected hexagonal part. For instance, the user may interact with the hexagonal part with ID “chi1,” using the user device, to request the OMS for generation of dashboards for inspecting a plurality of performance metrics associated with an application or service in the located in Chicago. In several implementations, the user interacts with the honeycomb 602 by using a “mouse pointer” to “click” on the desired hexagonal part or by using “keyboard shortcut keys” predefined for the desired hexagonal part. Other implementations are contemplated.

As shown in FIG. 6B, the dashboards at least comprise a dashboard 610 depicting number of configuration events with respect to time, dashboard 612 depicting application connectivity latency with respect to time, and dashboard 614 depicting device health. It is noted that these dashboards have been presented as non-limiting examples, and numerous alternative dashboards are possible. These are contemplated.

In an implementation, based on the dashboards, a user, such as IT Manager, may be able to determine issues at a given location (e.g., Chicago), as well as root-cause the issues for prompt resolution. For example, as shown in the figure, dashboard 610 depicts an increase in the number of configuration events between 10:10 to 10:20 AM. Further, dashboard 612 depicts a change in the application connectivity latency during the same time period. Furthermore, according to dashboard 614, a number of devices (from devices identified as DV_01 to DV_24) have been flagged as having issues (as represented by shaded hexagonal parts). Based on these dashboards, the user may be able to identify the root-cause of the issues and collaborate with other users to resolve these.

In an implementation, the dashboards 610, 612 and 614 are created by the OMS in response to receiving plain text queries from the user device. For example, a user may simply write “\Chicago config events as column” in the GUI of an application (e.g., an IM application or a dedicated OMS application), and the system is configured to generate the dashboard 610 based on one or more NLP techniques, as described with respect to FIG. 5. Dashboards 612 and 614 are similarly generated. Each dashboard may be updated in real-time or near-real time as well as can be shared between multiple users.

FIG. 7 illustrates an exemplary graphical user interface (GUI) of a user device displaying a dashboard for inspecting performance metrics of a service being monitored. As shown, dashboard 700 displays two performance metrics, i.e., device health 702, and event alerts 704. It is noteworthy that numerous other performance metrics may be displayed and are therefore within the scope of the present application.

In an implementation, the device health 702 performance metric may be displayed as a honeycomb structure 706. In one example, the device health 702 metric may be indicative of the overall functioning and performance of a device, such as a computer, router, switch, and the like. In an implementation, the device health 702 can include factors such as the device's operating system, available storage space, battery life, and the performance of its hardware components. In some cases, device health 702 may also include physical condition of the device, such as the cleanliness of its components or the wear and tear on its hardware.

As shown in the figure, the devices for which device health 702 metric has been flagged, are depicted by shaded hexagons within the honeycomb structure 706. In an implementation, the OMS may determine which devices are flagged based on one or more of parameters received from the device, event information associated with the device, connectivity information related to the device received from a user device, and the like. Further, the OMS can also be configured to learn what behavior is deemed “healthy” for a given device, based at least in part on, recorded values (e.g., a stored history) of one or more metrics associated with the given device. Based on such a history, the OMS can then identify anomalies in the device behavior and flag the device for its device health 702, when such anomalies are identified.

In an implementation, the dashboard 700 further displays an event alert table 704 indicative of one or more events associated with the service being monitored. As depicted, the event alert table 704 includes an ID field 708, Alert Name field 710, Alert state Field 712, labels field 714, and timestamp field 716. For example, the ID field 708 displays an alphanumeric string identifying a given alert. Further, alert name 710 describes the type of alert (e.g., Interface traffic issue) and alert state 712 displays whether the issue is active or dormant. In an implementation, the label field 714 includes contextual data. In the form of device ID, for a given alert, such that a user can easily identify the device owing to which the alert has been generated. For example, as shown in the figure, all alerts are generated for the device “L151.” Further, timestamp 716 shows the time at which the alert was generated.

A user interacting with the dashboard 700, using a user device, may edit various fields of the dashboard 700, in order to filter data shown in the dashboard 700. For example, the user can set a period of time for which data is needed using the time field 720. Similarly, the user can choose to view information solely for devices that are in violation by toggling the “violations only” switch 722. The user can further interact with the dashboards by specifying particular widgets by using a select widgets tab 724. Other actions can be performed using the actions drop down menu 726.

In an implementation, as user interacts with the dashboard 700, multiple other contextual dashboards may be generated, autonomously in real-time, and displayed at the GUI of the user device (as described in FIG. 6B). Further, each time a performance metric changes, the dashboard 700, and all other contextual dashboards created as result of interaction of the user with the dashboard 700, are appropriately updated.

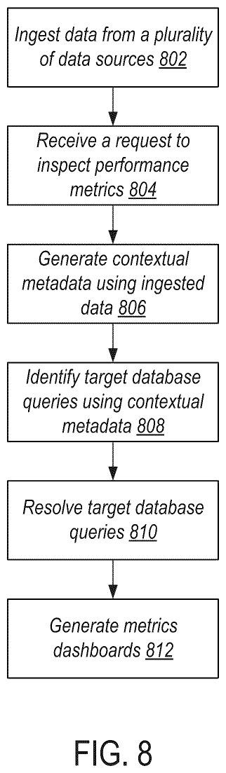

FIG. 8 illustrates a method for generating performance metric dashboards. As described in the foregoing, an operations management system (OMS) receives a query from a user device and presents on-demand real-time dashboards to the user device, by resolving the query. The dashboard can be presented on a graphical user interface of the user device for troubleshooting issues identified in a given hardware or software infrastructure.

In an implementation, the OMS ingests data from a plurality of data sources (block 802). The OMS ingests the data from multiple data sources, each associated with performance of elements of a particular hardware infrastructure (e.g., physical datacenters) or software infrastructure (e.g., cloud or network-based services). The data includes information relating to performance metrics as given by events, metrics, logs, and configurations associated with the hardware or software infrastructure. Further, data sources can also include monitoring systems and/or log-collection systems.

The OMS can receive a request to inspect one or more performance metrics of the given hardware or software infrastructure (block 804). In an implementation, the request is received from a user device in the form of a plain text message. The OMS, responsive to receiving the query generates contextual metadata from the ingested data (block 806). In one implementation, the contextual metadata is generated in the form of labels, such that the ingested data, when infused with these labels, can be cross correlated to monitor performance metrics of the infrastructure being monitored.

The OMS is then configured to identify all possible database queries using the contextual metadata (block 808). In an implementation, the OMS uses the contextual metadata to generate a plurality of database queries, such that a given database query, when resolved, provides information on one or more performance metrics of the infrastructure being monitored. For instance, the OMS generates all possible database queries for processed data stored in various repositories.

Once all possible database queries have been generated, the OMS can resolve one or more target database queries (block 810). That is, the OMS identifies target queries from the list of all possible queries, such that resolving the target queries would provide real-time information on performance metrics requested to be inspected by the user device.

Based on the resolved queries, the OMS generates one or more performance metrics dashboards to be displayed on the GUI of the user device (block 812). In an implementation, the OMS is configured to generate on-demand dashboards for display on one or more GUI of a user device. The on-demand dashboards can facilitate a user of a given user device (such as an IT administrator), to root-cause an issue with a given service 104 and troubleshoot the issue, without the requirement of an additional monitoring tool or application on the user device. Further, the on-demand dashboards are updated in real-time such that every event occurrence for the monitored infrastructure is accessible to the user concurrently, thereby reducing time spent on root-causing of the issue(s).

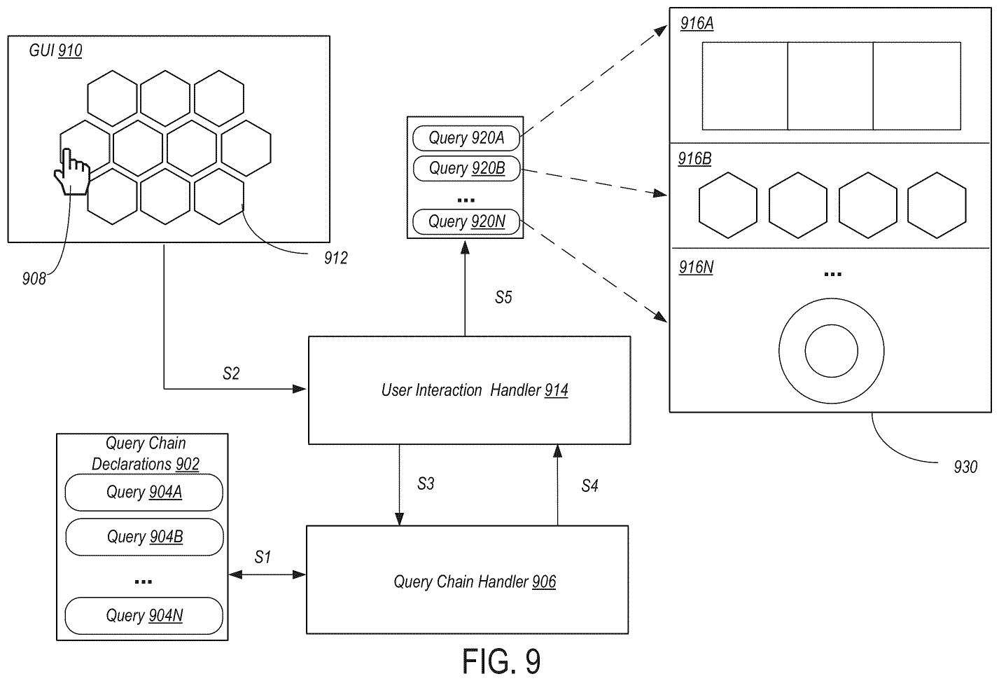

FIG. 9 illustrates an exemplary block diagram depicting generation of performance metric dashboards using query chain declarations. As described in the foregoing, data associated with operational parameters of one or more services being monitored is collected by an Operations Management System (OMS), e.g., the OMS 200 described in FIG. 2. The collected data is processed, based at least in part on policy-based and/or heuristic-based rules to create contextual metadata. The metadata is further utilized to generate a plurality of database queries to enable querying of the performance metrics of the operational parameters, by one or more user devices. In response to inputs received from a given user device, the OMS is configured to generate metrics dashboards to be presented on a graphical user interface of the user device. Using these dashboards, the user device is enabled to identify issues in the hardware or software infrastructure of the inspected services.

As shown in the figure, a query chain 902 is configured using declarative programming methods, such that the query chain 902 comprises of one or more queries 904A-N (shown as step S1). In an implementation, declaration of the queries is performed so as to specify details of the query 904 that is to be executed against one or more databases. In an example, declaring a query 904 includes specifying tables, columns, and conditions to be used in the query 904, as well as any sorting or grouping that should be applied. For example, for a given query 904 created using SQL, declaring a query may involve using a SELECT command to specify columns to be returned, a FROM command to specify tables to be queried, and a WHERE command to specify any filtering conditions. Once the query 904 is declared, it can be executed against a given database to retrieve desired data.

In an implementation, the query chain 902, refers to a sequence of queries, i.e., queries 904A-N, that are executed in a specific order to retrieve information from a database or a system. According to the implementation, the output of a given query 904 may serve as an input for the next query in the chain. In an example, the query chain 902, comprising of the queries 904A-N, are configured by the OMS and transmitted to a query chain handler 906. In one implementation, the query chain handler 906 is integral to the OMS. In another implementation, the query chain handler 906 can be an independent computing unit or module.

As shown in the figure, a user input 908 is received at a graphical user interface (GUI) 910 (step S2), e.g., running on a given user device (not shown), such that responsive to the user input, one or more dashboards are created and presented by the OMS. In the example shown in the figure, the user input 908 is received with respect to a high-level dashboard 912, that may be indicative of operational parameters of a plurality of services (each depicted by individual hexagonal units within the dashboard 912). In one implementation, in order to view one or more granular dashboards-generated for a selected individual service or location-an end user can provide the user input 908, through the GUI 910, as shown. The granular dashboards, in an example, may provide low-level data of operational parameters for the selected service, to facilitate for troubleshooting of any identified issues.

In an implementation, the high-level dashboard 912 is created by the OMS in response to receiving plain text queries from the user device. For example, a user may simply write “\Show services location as honeycomb” in the GUI 910 of an application (e.g., an IM application or a dedicated OMS application), and the OMS is configured to generate the dashboard 912 based on one or more NLP techniques, as described with respect to FIG. 5.

In an implementation, this user input 908 is received by a user interaction handler 914, which may be integral to the OMS or an independent processing unit. When a user interacts with the GUI 910, the user input 908, such as clicking a button or entering text into a field, is captured as an event by the GUI framework. The GUI framework passes the event to the appropriate component (e.g., button or text field) and triggers the user interaction handler 914. This user interaction handler 914 is configured to process the user input 908 and converting it into executable instructions for the query chain handler 906 to process (step S4).

In an implementation, the query chain handler 906 is configured to receive the executable instructions from the user interaction handler 914 and identify one or more queries 904, from the declared query chain 902 to be resolved. According to the implementation, resolving the identified one or more queries 904, to generate resolved queries 920A-N, results in creation of desired plurality of dashboards 916. The resolved queries 920A-N are passed onto the user interaction handler 914 by the query chain handler 906 (step S4). Further, the user interaction handler 914 is configured to utilize each resolved query 920A-N to create an associated dashboard 916 the plurality of dashboards 916 (step S5).

The plurality of dashboards 916, in one implementation, are generated in order to provide granular insights into operational parameters of the services or locations being monitored using the high-level dashboard 912. In an implementation, the high-level dashboard 912 can also be generated by resolving one or more queries 904 from the query chain 902, e.g., responsive to textual inputs received from a given user device through the GUI 910. Other implementations of user inputs are contemplated. As the queries 904 are executed in a specific order to retrieve information, each query resolved to generate a high-level dashboard (e.g., dashboard 912) is followed by resolution of one or more other queries 904 to generate one or more granular dashboards (e.g., dashboards 916).

In an example, the high-level dashboard 912 may identify different locations at which services are being monitored. In an implementation, the monitored services include one or more of a cloud-based service, a network-based service, a hardware service, a software service, or a combination thereof. According to the example, if the user input 908 selects a given location, the query chain handler 906 identifies queries 904 from the query chain 902 and resolves these queries to generate the resolved queries 920A-N. The resolved queries 920A-N is then used by the user interaction handler 914, to generate respective dashboards 916. For example, for a selected location, a dashboard 916A is generated using resolved query 920A. In the example, the dashboard 916A can identify an operational parameter, such as device health of devices running within the monitored service at the selected location. The dashboard 916A, as shown, can depict the various devices' device health onto a GUI 930 in the form of individual units 922A-N. It is noteworthy that although the device health parameter is depicted using squares, each operational parameter may be depicted using various shapes and color coding, and these are within the scope of the present application. Further, the dashboards 916 can be depicted onto the GUI 930 or the GUI 910 through which the user input 908 was first received.

Similarly, using other resolved queries 920, the user interaction handler 914 can generate different dashboards such as dashboard 916B using resolved query 920B, and so on. Each dashboard 916 is indicative of one or more operational parameters of the service being monitored. Further, responsive to identifying interaction of a user device with a given dashboard 916, the query chain handler 906 resolves more sequential queries to generate further dashboards that depict more granular information about an operational parameter than that available using preceding dashboards. This way, an end user can quickly and easily generate dynamic dashboards in an existing GUI, using which issues can be identified and troubleshooted efficiently, without requiring extensive manual efforts and collaboration.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. A system comprising:
a processing unit configured to:
receive, from a user device, a request to inspect one or more performance metrics of at least one network connected service;
generate contextual metadata from data ingested from one or more data sources associated with the at least one network connected service;
identify a plurality of database queries generated based at least in part on the contextual metadata;
resolve at least a portion of the plurality of database queries, wherein each query of the portion of the plurality of database queries represents at least one performance metric of the one or more performance metrics; and
generate one or more dashboards facilitating inspection of each of the one or more performance metrics based at least in part on the resolved portion of the plurality of database queries.

2. The system as claimed in claim 1, wherein the one or more parameters are comprised within a plurality of parameters, and wherein each of the plurality of parameters is associated with at least one database query of the plurality of database queries.

3. The system as claimed in claim 1, wherein the processing unit is further configured to generate a second set of performance metrics, responsive to the requested inspection of one or more performance metrics, the second set of performance metrics generated based on the contextual metadata.

4. The system as claimed in claim 1, wherein the processing unit is further configured to dynamically modify the generated one or more dashboards in real-time or near real-time.

5. The system as claimed in claim 1, wherein the processing unit is further configured to:
decouple the ingested data from its data source;
normalized the decoupled data;
identify at least one label for the decoupled data to generate labeled data; and
generate the contextual metadata, wherein the contextual metadata at least comprises the labeled data.

6. The system as claimed in claim 1, wherein the request received from the user device comprises natural language text, and wherein the processing unit is further configured to resolve the at least the portion of the plurality of database queries based in part on processing the natural language text using a natural language processing (NLP) model.

7. The system as claimed in claim 1, wherein the plurality of database queries is comprised in a query chain, and wherein the portion of the plurality of database queries are resolved in a sequential manner.

8. A method comprising:
receiving, from a user device by a processor, a request to inspect one or more performance metrics of at least one network connected service;
generating, by the processor, contextual metadata from data ingested from one or more data sources associated with the at least one network connected service;
identifying, by the processor, a plurality of database queries generated based at least in part on the contextual metadata;
resolving, by the processor, at least a portion of the plurality of database queries, wherein each query of the portion of the plurality of database queries represents at least one performance metric of the one or more performance metrics; and
generating, by the processor, one or more dashboards facilitating inspection of each of the one or more performance metrics based at least in part on the resolved portion of the plurality of database queries.

9. The method as claimed in claim 8, wherein the one or more parameters are comprised within a plurality of parameters, and wherein each of the plurality of parameters is associated with at least one database query of the plurality of database queries.

10. The method as claimed in claim 8, further comprising generating, by the processor, a second set of performance metrics, responsive to the requested inspection of one or more performance metrics, the second set of performance metrics generated based on the contextual metadata.

11. The method as claimed in claim 8, further comprising dynamically modifying, by the processor, the generated one or more dashboards in real-time or near real-time.

12. The method as claimed in claim 8, further comprising:
decoupling, by the processor, the ingested data from its data source;
normalizing, by the processor, the decoupled data;
identifying, by the processor, at least one label for the decoupled data to generate labeled data; and
generating, by the processor, the contextual metadata, wherein the contextual metadata at least comprises the labeled data.

13. The method as claimed in claim 8, wherein the request received from the user device comprises natural language text, and wherein the method further comprising resolving, by the processor, the at least the portion of the plurality of database queries based in part on processing the natural language text using a natural language processing (NLP) model.

14. The method as claimed in claim 8, wherein the plurality of database queries is comprised in a query chain, and wherein the portion of the plurality of database queries are resolved in a sequential manner.

15. A computing system comprising:
a central processing unit; and
an operations management unit configured to:
receive, from a user device, a request to inspect one or more performance metrics of at least one network connected service;
generate contextual metadata from data ingested from one or more data sources associated with the at least one network connected service;
identify a plurality of database queries generated based at least in part on the contextual metadata;
resolve at least a portion of the plurality of database queries, wherein each query of the portion of the plurality of database queries represents at least one performance metric of the one or more performance metrics; and
generate one or more dashboards facilitating inspection of each of the one or more performance metrics based at least in part on the resolved portion of the plurality of database queries.

16. The system as claimed in claim 15, wherein the one or more parameters are comprised within a plurality of parameters, and wherein each of the plurality of parameters is associated with at least one database query of the plurality of database queries.

17. The system as claimed in claim 15, wherein the processing unit is further configured to generate a second set of performance metrics, responsive to the requested inspection of one or more performance metrics, the second set of performance metrics generated based on the contextual metadata.

18. The system as claimed in claim 15, wherein the processing unit is further configured to dynamically modify the generated one or more dashboards in real-time or near real-time.

19. The system as claimed in claim 15, wherein the processing unit is further configured to:
decouple the ingested data from its data source;
normalized the decoupled data;
identify at least one label for the decoupled data to generate labeled data; and
generate the contextual metadata, wherein the contextual metadata at least comprises the labeled data.

20. The system as claimed in claim 15, wherein the request received from the user device comprises natural language text, and wherein the processing unit is further configured to resolve the at least the portion of the plurality of database queries based in part on processing the natural language text using a natural language processing (NLP) model.
